(19) United States
(12) Patent Application Publication
(10) Pub. No.: US 2016/0297170 A1
(43) Pub. Date: Oct. 13, 2016

(54) DOOR WITH INSERT AND METHODS FOR MAKING AND USING SAME

(71) Applicant: Jeffrey Bryan Prescott, Dallas, TX (US)

(72) Inventor: Jeffrey Bryan Prescott, Dallas, TX (US)

(21) Appl. No.: 15/094,756

(22) Filed: Apr. 8, 2016

Related U.S. Application Data
(60) Provisional application No. 62/144,848, filed on Apr. 8, 2015.

(51) Int. Cl. B32B 3/30; E06B 7/00; E06B 3/54; E06B 3/84; B32B 3/26; B32B 3/08

(52) U.S. Cl. CPC B32B 3/30; B32B 3/266; B32B 3/08; E06B 3/5418; E06B 3/84; E06B 7/00; B32B 2419/00

(57) ABSTRACT

Doors with inserts and methods for making and using same. In one example, the door can include a body and an insert. The body can include an intermediate layer disposed between a first exterior layer and a second exterior layer. A recess can be formed in the intermediate layer. An insert can be at least partially disposed within the recess. An opening can be defined by a first end of the intermediate layer and the first exterior layer that can enable the insert to be removed from the recess to an exterior of the body. At least a portion of the insert can be exposed to the exterior of the body through an opening defined by the first exterior layer. The first exterior layer can be in contact with the insert to retain the insert within the recess.

### CROSS-REFERENCE TO RELATED APPLICATION

This application claims priority to U.S. Provisional Patent Application No. 62/144,848, filed on Apr. 8, 2015, which is incorporated by reference herein.

### BACKGROUND

1. Field

Embodiments described generally relate to doors. More particularly, such embodiments relate to doors that can include an insert, such as a mirror, and methods for making and using same.

2. Description of the Related Art

Mirrors are often installed on a face of a door. For example, it is frequently desirable to include a mirror on bedroom doors, closet doors, bathroom doors, dressing room doors, as well as other doors to enable a viewing the attire of the wearer. Mirrors are typically installed on the face of the door by securing a framed mirror to the face of the door with mechanical fasteners or using an adhesive to adhere the mirror to the door.

If a mirror is broken and needs to be replaced, the door can easily be damaged during the removal of the mirror, especially when the mirror is secured to the door with an adhesive. Sometimes the door can be damaged beyond repair and must also be replaced. Additionally, the time required to replace the mirror, when done on a large scale, e.g., in a hotel or other commercial or private property, that frequently may have a large number of mirrored doors, and hence a rather high rate of broken mirrors can also add to the costs necessary to maintain the property.

There is a need, therefore, for improved doors that include a mirror on a face thereof that can be removed and/or replaced and methods for making and using same.

### SUMMARY

Doors with inserts and methods for making and using same are provided. In one example, the door can include a body and an insert. The body can include an intermediate layer disposed between a first exterior layer and a second exterior layer. A recess can be formed in the intermediate layer. An insert can be at least partially disposed within the recess. An opening can be defined by a first end of the intermediate layer and the first exterior layer that can enable the insert to be removed from the recess to an exterior of the body. At least a portion of the insert can be exposed to the exterior of the body through an opening defined by the first exterior layer. The first exterior layer can be in contact with the insert to retain the insert within the recess.

In another example, the door can include a body and an insert. The body can include a first exterior layer, a first intermediate layer, a second intermediate layer, a third intermediate layer, and a second exterior layer. The second intermediate layer can be disposed between the first exterior layer and the first intermediate layer. The third intermediate layer can be disposed between the second exterior layer and the first intermediate layer. A recess can be formed in the first intermediate layer. An insert can be at least partially disposed within the recess. An opening can be at least partially defined by a first end of the first intermediate layer and the second intermediate layer that can enable the insert to be removed from the recess to an exterior of the body. At least a portion of the insert can be exposed to the exterior of the body through an opening defined by the first exterior layer and the second intermediate layer. The second intermediate layer can be in contact with the insert to retain the insert within the recess.

In another example, the door can include a body that can include a first exterior layer, a first intermediate layer, a second intermediate layer, a third intermediate layer, and a second exterior layer. The second intermediate layer can be disposed between the first exterior layer and the first intermediate layer. The third intermediate layer can be disposed between the second exterior layer and the first intermediate layer. A recess can be formed in the first intermediate layer. The recess can be configured to receive an insert through an opening defined by a first end of the intermediate layer and the second intermediate layer. The body can be configured to expose only a portion of the insert to an exterior of the body through an opening defined by the first exterior layer and the second intermediate layer.

### BRIEF DESCRIPTION OF THE DRAWINGS

FIG. 1 depicts an elevational view of an illustrative door that includes a body and an insert, according to one or more embodiments described.

FIG. 2 depicts an exploded perspective view of the door shown in FIG. 1.

FIG. 3 depicts a top view of the door shown in FIG. 1.

FIG. 4 depicts an exploded perspective view of another illustrative door that includes a body and an insert, according to one or more embodiments described.

FIG. 5 depicts a top view of the door depicted in FIG. 4 once assembled.

FIG. 6 depicts a top view of another illustrative door that includes a body and an insert, according to one or more embodiments described.

### DETAILED DESCRIPTION

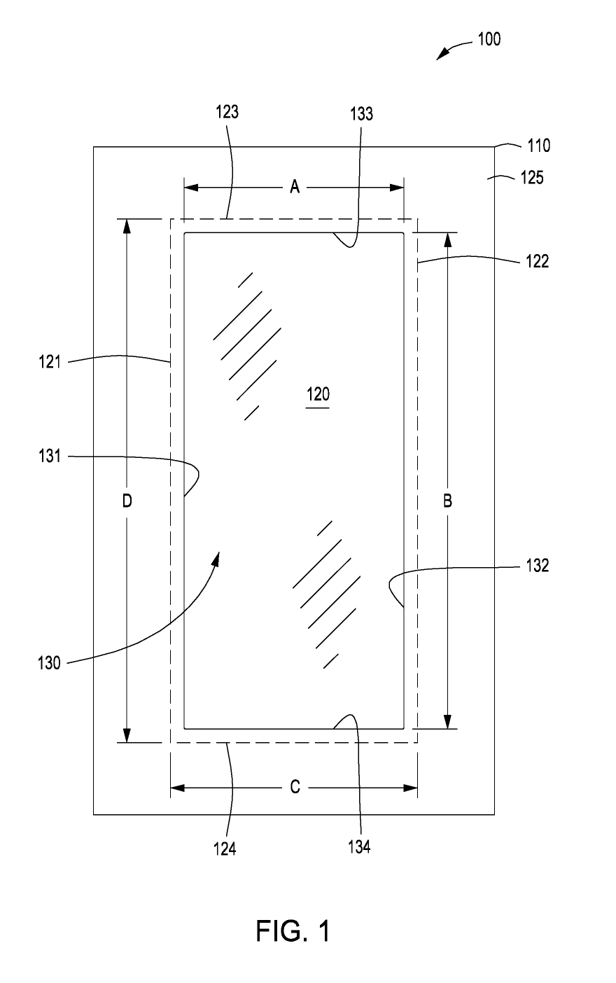

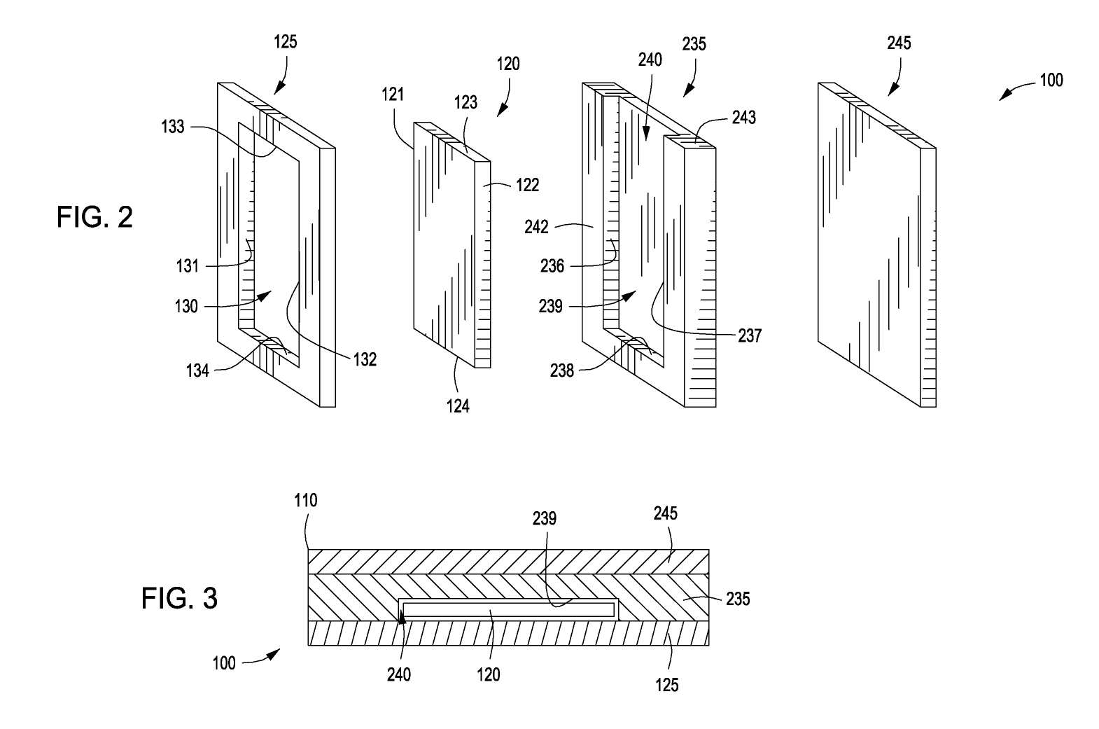

FIG. 1 depicts an elevational view of an illustrative door 100 that includes a body 110 and one or more inserts 120, according to one or more embodiments. FIG. 2 depicts an exploded perspective view and FIG. 3 depicts a top view of the door 100 shown in FIG. 1, respectively. The body 110 can be composed of or otherwise include three or more layers. For example, the body 110 can be composed of or otherwise include a first exterior layer or “face” 125, an intermediate layer or “core” 235, and a second exterior layer or “face” 245. The first exterior layer 125, the intermediate layer 235, and the second exterior layer 245 can be attached, coupled, bonded, adhered, or otherwise secured to one another to provide the body 110. For example, the first exterior layer 125, the intermediate layer 235, and the second exterior layer 245 can be secured to one another with one or more adhesives or binders to form or provide the body 110. In some examples, the first exterior layer 125, the intermediate layer 235, and the second exterior layer 245 can be secured to one another with one or more adhesives to provide the body 110 and the body 110 can be free of any mechanical fastener such as nails, screws, staples, pins, rivets, bolts, or the like.

The insert 120 can be at least partially located or otherwise disposed within a groove, cavity, channel, or recess 240 that can be formed in or otherwise defined by the intermediate layer 235. In one example, the recess 240 can have a rectangular prism shape. The recess 240 formed in the intermediate layer 235 can be defined by a first or “left” side 236, a second or “right” side 237, a third or “bottom” side 238, and a fourth or “back” side 239. The fifth or “front” side and the sixth or “top” side that also define the recess 240 can be open or otherwise exposed to an exterior of the intermediate layer 235. The fifth side of the recess 240 can be open or otherwise exposed to the exterior of the intermediate layer 235 and can lie in a plane of a first or “front” side 242 of the intermediate layer 235. The sixth side of the recess 240 can be open or otherwise exposed to the exterior of the intermediate layer 235 and can lie in a plane of a first or “top” end 243 of the intermediate layer 235. Accordingly, the recess 240 formed in the intermediate layer 235 can be referred to as having a first side 236, a second side 237, a third side 238, and fourth side 239, and fifth and sixth sides that are open or otherwise exposed to the exterior of the intermediate layer 235. In one example, the recess 240 can be exposed to the exterior of the body 110 by the opening defined by the first end 243 of the intermediate layer 235. In one example, the recess 240 can be exposed to the exterior of the body 110 by an opening 130 defined by the first exterior layer 125.

In some examples, the distance or depth the recess 240 can extend from the first side 242 to the fourth side 239, can be about 1 mm, about 1.5 mm, about 2 mm, about 2.5 mm, or about 3 mm to about 3.5 mm, about 3.7 mm, about 4 mm, about 4.5 mm, about 5 mm, about 7 mm, about 10 mm, about 13 mm, about 15 mm, or about 20 mm. In one example, the recess 240 can have a depth of about 2.5 mm to about 3.5 mm or about 3 mm to about 3.3 mm. In some examples, the recess 240 can have a width of about 1 cm, about 5 cm, about 10 cm, about 20 cm, about 30 cm, or about 40 cm to about 45 cm, about 50 cm, about 60 cm, about 70 cm, about 80 cm, about 90 cm, or more. The depth and width of the recess 240 can depend, at least in part, on the thickness and width of the particular insert(s) 130 to be disposed therein. The depth and width of the recess 240 can depend, at least in part, on the thickness and width of the intermediate layer 235 and/or the door 100.

It should be noted that the recess 240 can have any desired three-dimensional shape. For example, the recess 240 can have a triangular prism shape. In one example, the sides of the recess that extend along length of the door 100, e.g., the first side 236 and the second side 237 can be substantially parallel with one another. In another example, the sides of the recess that extend along length of the door 100, e.g., the first side 236 and the second side 237 can be directed toward one another as the edges move from a top of the door 100, e.g., the sixth side of the recess 240, toward a bottom of the door 100.

The insert 120 can be introduced to and/or removed from the recess 240 through the sixth or “top” side of the recess 240. As shown in FIG. 3, the insert 120 can move or otherwise pass through the sixth side of the recess 240 that can be open or otherwise exposed to the exterior of the body 110. Said another way, the insert 120 can be movable between the recess 240 and the exterior of the body 110 through the opening defined by the first end of the intermediate layer 235. In one example, the door 100 can be positioned in a horizontal or substantially horizontal position and the insert 120 can be slid or otherwise moved into and/or out of the recess 240. Depending, at least in part, on a height or distance of any ceiling or other structure that may be above the door 100 when the door 100 is installed (e.g., in a wall), the insert 120 may be moved into and/or out of the recess 240 when the door 100 is installed. The insert 120 can be retained within the recess 240 by the first layer 125 and the intermediate layer 235. The insert 120 can be supported or at least partially supported by the first side 236, the second side 237, and/or the third side 238 of the recess 240. It should be noted that having the recess 240 accessible from the exterior of the door 100, the insert 120 can be readily inserted and/or removed from the door 100 without the need to remove any mechanical fasteners, break any adhesive bond securing the mirror to the door, or other additional element that was used to secure the insert within the recess 240.

The opening 130 can be defined by the first exterior layer 125. For example, the opening 130 can have a rectangular shape defined by sides or edges 131, 132, 133, and 134. The opening 130 can expose at least a portion of the inert 120, such that the at least a portion of the insert 120 is visible when looking at the first exterior layer 125 of the body 110. It should be noted, however, that while a rectangular shape is shown, the opening 130 can have any desired shape. For example, the opening 130 can be rectangular, elliptical, triangular, or any combination thereof. Additionally, any number of openings 130 can be defined by the first exterior layer 125. For example, the first exterior layer 125 can define 1, 2, 3, 4, 5, 6, 7, 8, 9, or 10 to about 20, about 50, about 100, about 500, or about 1,000, or more separate openings.

The opening 130 defined by the first exterior layer 125 can have a width of “A” and a length of “B”. The width “A” and length “B” can be of any desired dimension. For example, the width “A” of the opening can be from a low of about 1 inch, about 3 inches, about 5 inches, about 10 inches, or about 15 inches to a high of about 20 inches, about 25 inches, about 30 inches, about 40 inches, about 50 inches, or more. The length “B” of the opening can be from a low of about 1 inch, about 3 inches, about 5 inches, about 10 inches, about 15 inches, about 30 inches, about 40 inches, or about 50 inches to a high of about 60 inches, about 70 inches, about 80 inches, about 90 inches, about 100 inches, about 110 inches, about 120 inches, or more.

The insert 120 can have a rectangular shape defined, in part, by edges 121, 122, 123, and 124 (dotted lines in FIG. 1) that can extend past the edges 131, 132, 133, and 134 of the first exterior layer 125. As such, the insert 120 can have a width “C” and a length “D” (or other dimension(s) depending, at least in part, on the particular shape of the opening 130) that can retain the insert 120 within the recess 240 and prevent the insert 120 from passing through the opening 130. Said another way, in one example, an area of the insert 120 can be greater than an area of the opening 130 such that the insert 120 (when intact) cannot pass through the opening 130. For example, the width “C” of the insert 120 can be greater than the width “A” of the opening 130 and the length “D” of the insert 120 can be greater than the length “B” of the opening 130. The insert 120 may be broken, disassembled, or otherwise deconstructed into two or more pieces and the deconstructed pieces, in some examples, may be able to be moved into and/or removed from the recess 240 through the opening 130. In one example, the insert 120 can be an integral body and not capable of passing through the opening 130 of the body 110 when the first exterior layer 125, the intermediate layer 235, and the second exterior layer 145 are secured to one another. In one example, an inner surface of the first exterior layer 125 can contact the insert 120 and prevent the insert 120 from passing through the opening 130 defined by first exterior layer 125.

In some examples, the edges 131, 132, 133, and 134 of the opening 130 can be free of any molding, where the purpose or function of the molding is to retain the insert 120 within the opening 130. In other examples, the edges 131, 132, 133, and 134 of the opening 130 can be free of any molding to retain the insert 120 within the opening 130. In some examples, the edges 131, 132, 133, and 134 of the opening 130 can be free of any molding or other fastener, e.g., clips, pins, or the like, where the purpose or function of the molding or other fastener is retain the insert 120 within the opening 130. In other examples, the edges 131, 132, 133, and 134 of the opening 130 can be free of any molding or other fastener, e.g., clips, pins, or the like, that retain the insert 120 within the opening 130. As such, by making the recess 240 accessible from the exterior of the door 100, the insert 120 can be readily inserted and/or removed from the door 100 without the need to remove any molding or other fastener and/or adhesive that retain the insert 120 within the recess 240. In some examples, the insert 120 can be at least partially disposed within the recess 140 without any mechanical fastener or adhesive used to secure the insert 120 within the recess 140. The insert 120 can installed or removed from the first end 243 of the intermediate layer 235 without removing any attachments or securements. As such, the insert 120 can be referred to as a “drop-in” insert 120.

In some examples, a first side of the first exterior layer 125 can form or otherwise be at least a portion of a first exterior side of the door 100 and a first side of the second exterior layer 245 can form or otherwise be at least a portion of a second exterior side of the door 100. A second side of the first exterior layer 125 can be secured to a first side of the intermediate layer 235. A second side of the second exterior layer 245 can be secured to a second side of the intermediate layer 235. Accordingly, the body 110 can include the first exterior layer 125 secured to the first side of the intermediate layer 235 and the second exterior layer 245 secured to the second side of the intermediate layer 235. When the insert 120 is at least partially disposed within the body 110, a portion of the insert can form or otherwise be at least a portion of the first exterior side of the door 100.

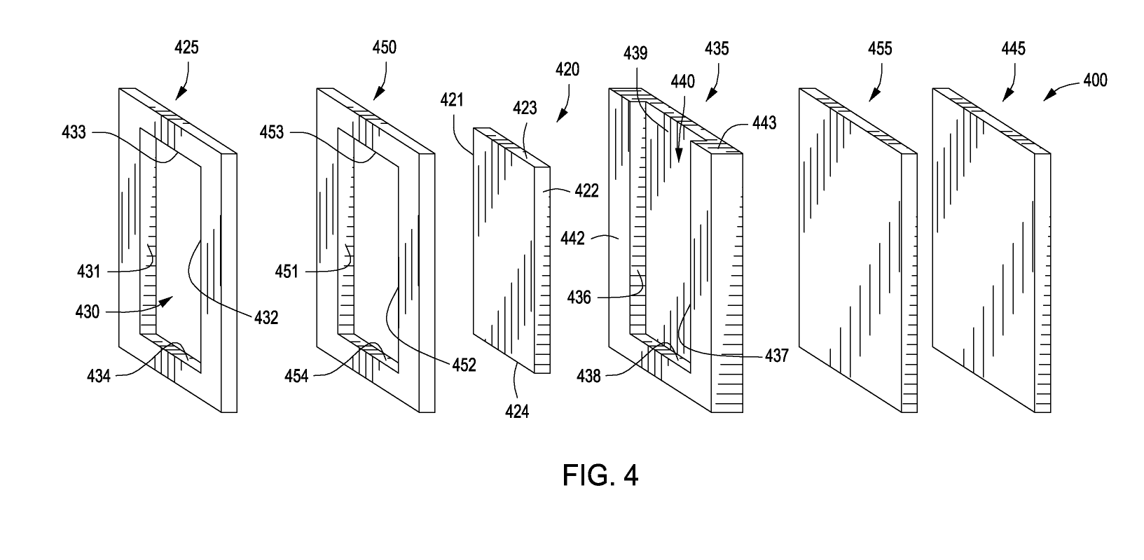

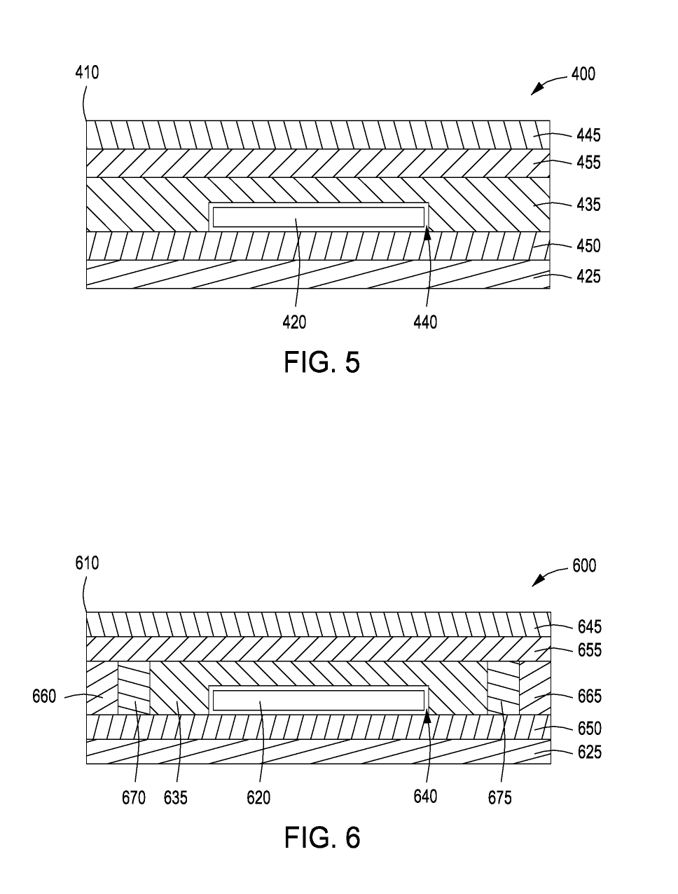

FIG. 4 depicts an exploded perspective view and FIG. 5 depicts a top view of another illustrative door 400, respectively, according to one or more embodiments. The door 400 can include a body 410 (when assembled, see FIG. 5) and an insert 420. Similar to the body 110 of the door 100 discussed and described above with reference to FIGS. 1-3, the door 400 can include a body 410 that can be composed of multiple layers. Although not shown, the door 400 can have an elevational view that can be substantially similar or identical to the elevational view of the door 100 depicted in FIG. 1.

As shown, the body 410 can be composed of a first exterior layer or “face” 425, a first intermediate layer or “core” 435, and a second exterior layer or face “445”. The body 410 can also include a second intermediate layer 450 disposed between the first exterior layer 425 and the first intermediate layer 435. The body 410 can also include a third intermediate layer 455 disposed between the first intermediate layer 435 and the second exterior layer 445.

The first exterior layer 425, the second intermediate layer 450, the first intermediate layer 435, the third intermediate layer 455, and the second exterior layer 445 can be attached, coupled, bonded, adhered, or otherwise secured, e.g., with one or more adhesives or binders, to one another to provide the body. In some examples, the first exterior layer 425, the second intermediate layer 450, the first intermediate layer 435, the third intermediate layer 455, and the second exterior layer 445 can be secured to one another with one or more adhesives to provide the body 410 and the body 410 can be free of any mechanical fastener such as nails, screws, stables, pins, rivets, bolts, or the like.

The insert 420 can be at least partially located or otherwise disposed within a groove, cavity, channel, or recess 440 that can be formed in or otherwise defined by the first intermediate layer 435. The recess 440 can have a rectangular prism shape. It should be noted, however, that the recess 440 can have any desired three-dimensional shape as the recess 240 discussed and described above with reference to FIGS. 1-3. The recess 440 formed in the first intermediate layer 435 can be defined by a first or “left” side 436, a second or “right” side 437, a third or “bottom” side 438, and a fourth or “back” side 439. The fifth or “front” side and the sixth or “top” side that also define the recess 440 can be open or otherwise exposed to an exterior of the first intermediate layer 435. The fifth side of the recess 440 can be open or otherwise exposed to the exterior of the first intermediate layer 435 and can lie in a plane of a first or “front” side 442 of the first intermediate layer 435. The sixth side of the recess 440 can be open or otherwise exposed to the exterior of the first intermediate layer 435 and can lie in a plane of a first or “top” end 443 of the first intermediate layer 435. Accordingly, the recess 440 formed in the first intermediate layer 435 can be referred to as having a first side 436, a second side 437, a third side 438, and fourth side 439, and fifth and sixth sides that are open or otherwise in fluid communication with the exterior of the first intermediate layer 435. In one example, the recess 440 can be exposed to the exterior of the body 410 by the opening defined by the first end 443 of the first intermediate layer 435. In one example, the recess 440 can be exposed to the exterior of the body 410 by an opening 430 defined by the first exterior layer 425 and the second intermediate layer 450.

In some examples, the distance or depth the recess 440 can extend from the first side 442 to the fourth side 439, can be about 1 mm, about 1.5 mm, about 2 mm, about 2.5 mm, or about 3 mm to about 3.5 mm, about 3.7 mm, about 4 mm, about 4.5 mm, about 5 mm, about 7 mm, about 10 mm, about 13 mm, about 15 mm, or about 20 mm. In one example, the recess 440 can have a depth of about 2.5 mm to about 3.5 mm or about 3 mm to about 3.3 mm. In some examples, the recess 440 can have a width of about 1 cm, about 5 cm, about 10 cm, about 20 cm, about 30 cm, or about 40 cm to about 45 cm, about 50 cm, about 60 cm, about 70 cm, about 80 cm, about 90 cm, or more. The depth and width of the recess 440 can depend, at least in part, on the thickness and width of the particular insert(s) 130 to be disposed therein. The depth and width of the recess 440 can depend, at least in part, on the thickness and width of the first intermediate layer 435 and/or the door 400.

The insert 420 can be introduced to and/or removed from the recess 440 through the sixth or “top” side of the recess 440. As shown in FIG. 5, the insert 420 can move or otherwise pass through the sixth side of the recess 440 that is open or otherwise exposed to the exterior of the body 410. Said another way, the insert 420 can be movable between the recess 440 and the exterior of the body 410 through the opening defined by the first end of the first intermediate layer 435. In one example, the door 400 can be positioned in a horizontal or substantially horizontal position and the insert 420 can be slid or otherwise moved into and/or out of the recess 440. Depending, at least in part, on a height or distance any ceiling or other structure that may be above the door 400 when the door 400 is installed (e.g., in a wall), the insert 420 may be moved into and/or out of the recess 440 when the door 400 is installed. The insert 420 can be retained within the recess 440 by the first intermediate layer 435 and the first exterior layer 425, the second intermediate layer 250, or the first exterior layer 425 and the second intermediate layer 450. The insert 420 can be supported or at least partially supported by the first side 436, the second side 437, and/or the third side 438 of the recess 440. It should be noted that having the recess 440 accessible from the exterior of the door 400, the insert 420 can be readily inserted and/or removed from the door 400 without the need to remove any mechanical fasteners, break any adhesive bond securing the mirror to the door, or other additional element that was used to secure the insert within the recess 440.

The opening 430 can be defined by the first exterior layer 425 and the second intermediate layer 450. For example, the opening 430 can have a rectangular shape defined by sides or edges 431, 432, 433, and 434 of the first exterior layer and by sides or edges 451, 452, 453, and 454 of the second intermediate layer 450. The opening 430 can expose at least a portion of the inert 420, such that the at least a portion of the insert 420 is visible when looking at the first exterior layer 425 of the body 410. It should be noted, however, that while a rectangular shape is shown, the opening 430 can have any desired shape. For example, the opening 430 can be rectangular, elliptical, triangular, or any combination thereof. Additionally, any number of openings 430 can be defined by the first exterior layer 425 and the second intermediate layer 450. For example, the first exterior layer 425 and the second intermediate layer 450 can define 1, 2, 3, 4, 5, 6, 7, 8, 9, or 10 to about 20, about 50, about 100, about 500, or about 1,000, or more separate openings.

The opening 430 defined by the first exterior layer 425 and the second intermediate layer 450 can have a width and a length that are the same as or substantially similar to the width and length of the opening 130 discussed and described above with reference to FIGS. 1-3. In one example, the portion of the opening 430 defined by the first exterior layer 425 can have a first width and a first length and the portion of the opening 430 defined by the second intermediate layer 450 can have a second width and a second length. In one example, the first width can be the same or substantially the same as the second width and the first length can be the same or substantially the same as the second width. As such, the second intermediate layer 450 can be entirely concealed behind the first exterior layer 425 or only partially concealed behind the first exterior layer 425. In another example, the second width can be less than the first width and/or the second length can be less than the first length. As such, the second intermediate layer 450, when defining a smaller opening than the first exterior layer 425 can serve as a matte similar to a matte in a picture frame because portions of the second intermediate layer 450 can be seen when looking through the opening formed through the first exterior layer 425.

The insert 420 can have a rectangular shape defined by edges 421, 422, 423, and 424 that can extend past at least the edges 451, 452, 453, and 454 of the second intermediate layer 450. In at least one example, the insert 420 can have a rectangular shape defined by edges 421, 422, 423, and 424 that can extend past both the edges 451, 452, 453, and 454 of the second intermediate layer 450 and the edges 431, 432, 433, and 434 of the first exterior layer 425. In either example, the width and length of the insert 420 can be sufficient to retain the insert 420 within the recess 440 and prevent the insert 420 from passing through the opening 430. The insert 420 may be broken, disassembled, or otherwise deconstructed into two or more pieces and the deconstructed pieces, in some examples, may be able to be moved into and/or removed from the recess 440 through the opening 430. In one example, the insert 420 can be an integral body not capable of passing through the opening 430 of the body 410 when at least the first exterior layer 425, the second intermediate layer 450, and the first intermediate layer 435 are secured to one another. In one example, an inner surface of the second intermediate layer 450 can contact the insert 420 and prevent the insert 420 from passing through the opening 430 defined by first exterior layer 425 and the second intermediate layer 450.

In some examples, the edges 131, 132, 133, and 134 of the first exterior layer 125 that define the opening 130 and the edges 431, 432, 433, 434 of the first exterior layer 425 and the edges 451, 452, 453, and 454 of the second intermediate layer 450 that define the opening 430 can be free of any molding, caulking, adhesive, or other fastener, e.g., clips, pins, screws, nails, or the like, configured to retain the insert 120 within the opening 130. Said another way, the first exterior layer 125, the second intermediate layer 450, and/or the combination of the first exterior layer 425 and the second intermediate layer 450 can be used to retain the insert 120 within the recess 440 without any additional retaining mechanism, e.g., adhesive, molding, or other mechanical fasteners. In some examples, the insert 420 can be at least partially disposed within the recess 440 without any mechanical fastener or adhesive used to secure the insert 420 within the recess 440. The insert 420 can installed or removed from the first end 443 of the first intermediate layer 435 without removing any attachments or securements. As such, the insert 420 can be referred to as a “drop-in” insert 420.

In some examples, first side of the first exterior layer 425 can form or otherwise be at least a portion of a first exterior side of the door 400 and a first side of the second exterior layer 445 can form or otherwise be at least a portion of a second exterior side of the door 400. A second side of the first exterior layer 425 can be secured to a first side of the second intermediate layer 450. A second side of the second exterior layer 445 can be secured to a first side of the third intermediate layer 455. A second side of the second intermediate layer 450 can be secured to a first side of the first intermediate layer 435. A second side of the third intermediate layer 455 can be secured to a second side of the first intermediate layer 435. Accordingly, the body 410 can include the first exterior layer 425 secured to the first side of the second intermediate layer 450, the second side of the second intermediate layer 450 secured to the first side of the first intermediate layer 435, the second side of the third intermediate layer 455 secured to the second side of the first intermediate layer 435, and the first side of the third intermediate layer 455 secured to the second side of the second exterior layer 445. When the insert 420 is at least partially disposed within the body 410, a portion of the insert can form or otherwise be at least a portion of the first exterior side of the door 400.

FIG. 6 depicts a top view of an illustrative door 600 that includes a body 610 and an insert 620, according to one or more embodiments. The body 610 can include a first exterior layer or “face” 625, a first intermediate layer or “core” 635, and a second exterior layer or “face” 645. The body 610 can also include a second intermediate layer 650 and/or a third intermediate layer 655. The body 610 can further include a first edge stile 660, a second edge stile 665, a first intermediate stile 670, and/or a second intermediate stile 675. The stiles 660, 665, 670, and/or 675 can be disposed along edges of the first intermediate layer 635 and between the second intermediate layer 650 and the third intermediate layer 655, as depicted in FIG. 6. Although not shown, one or more optional “top rails” or stiles can be disposed adjacent a first or “top” end of the first intermediate layer 635 and/or one or more optional “bottom rails” or stiles can be disposed adjacent a second or “bottom” end of the first intermediate layer 635. The optional stiles disposed adjacent the top end and/or the bottom end of the first intermediate layer 635 can be disposed between the second intermediate layer 650 and the third intermediate layer 655. It should be noted that the doors 100 and/or 400 can also include one or more edge stiles, one or more “top rails” and/or one or more “bottom rails” similar to or in a same manner as the body 610.

Although not shown, one or more third exterior layers or faces can be disposed along a first or “top” end of the body 110, 410, and/or 610 that can at least partially cover the sixth side of the recess, thus inhibiting or preventing the insert 120 from being removed from the sixth side of the recess 240. Although not shown, one or more fourth exterior layers or faces can be disposed along a third or “left” side of the body 110, 410, and/or 610 that can at least partially cover the third side thereof. Although not shown, one or more fifth exterior layers or faces can be disposed along a fourth or “right” side of the body 110, 410, and/or 610 that can at least partially cover the fourth side thereof. Although not shown, one or more sixth exterior layers or faces can be disposed along a fourth or “bottom” side of the body 110, 410, and/or 610 that can at least partially cover the fourth side thereof. The optional third, fourth, fifth, and/or sixth exterior layers can be or include the same materials as the first exterior layers 125, 425 and the second exterior layers 245, 445 discussed and described above with reference to FIGS. 1-5.

Referring to the doors 100, 400, and 600 in some examples, one or more plugs, fillers, covers, or other secondary inserts (not shown) can be located within the recesses 240, 440, and/or 640 when the respective insert 120, 420, and/or 620 is located therein. In some examples, the he secondary insert can reduce, inhibit, or prevent movement of the inserts 120, 420, and/or 620 within the recesses 240, 440, and/or 640. For example, a clip, tab, pin, screw, block, or other structure can be at least partially inserted within the recesses 140, 440, and/or 640 and can contact the insert 120, 420, and/or 620 to reduce, inhibit, or prevent movement of the inserts 120, 420, 620. In other examples, the secondary insert can at least partially obstruct the opening defined by the first exterior layer 125 and the intermediate layer 235 at the first end 243 of the intermediate layer 245. Similarly, the secondary insert can at least partially obstruct the opening defined by the second intermediate layer 450 and the first intermediate layer 435 at the first end 443 of the first intermediate layer 445. In one example, one or more pieces of laminate or other relatively thin substrates can be cut to size and disposed within the opening defined by the first end 243 of the intermediate layer 235 and the first exterior layer 125. In one example, one or more pieces of laminate or other relatively thin substrates can be cut to size and disposed within the opening defined by the first end 443 of the core 445 and the second intermediate layer 450. In other examples, one or more covers (not shown) can be located one or adjacent to the first end 243 and/or 443 that can at least partially cover the opening defined by the first end 243 and/or 443 when the respective insert 120 and/or 420 is located therein. The cover can be, e.g., a laminate, veneer, or other layer disposed on or the first end 243 and/or 443. The door 600 can also include one or more covers in a similar manner as the doors 100 and/or 400.

In some examples, one or more materials can be disposed between the insert 120 and the intermediate layer 235 and/or the insert 120 and first exterior layer 125. Similarly, one or more materials can be disposed between the insert 420 and the first intermediate layer 435 and/or the insert 420 and the second intermediate layer 450. Similarly, one or more materials can be disposed between the insert 620 and the first intermediate layer 635 and/or the insert 620 and the second intermediate layer 650. For example, a strip of foam, rubber, plastic, or the like can be located or otherwise disposed between the insert 120 and the first side 236, the second side 237, the third side 238, the fourth side 239 of the recess 240 and/or the first exterior layer 125. The one or more materials can reduce the tendency for the insert 120 to move within the recess 240 when disposed therein. Such material can reduce or prevent the insert 120 from rattling or otherwise moving within the door 100 when the door 100 is moved such as when the door 100 is installed in a wall and is opened or closed. In another example, one or more pieces of a relatively thin material, e.g., strips of laminate, can be used to shim-up the insert 130 within the recess 235. Similarly, one or more materials can be disposed between the insert 420 and the first intermediate layer 435 and/or the insert 420 and the second intermediate layer 450. Similarly, one or more materials can be disposed between the insert 620 and the first intermediate layer 635 and/or between the insert 620 and the second intermediate layer 650.

The inserts 120, 420, and/or 620 can be or include, but are not limited to, a mirror, a silicate based glass, acrylic glass, a chalk board, a dry erase board, wood, a laminate, glass, paper, an electronic display, a light, or any combination thereof. In one example the insert 120, the insert 420, and/or the insert 620 can be or include a silicate based glass. Silicate based glass can be or include, but are not limited to, fused quartz, soda-lime-silica glass, sodium borosilicate glass, lead-oxide glass, aluminosilicate glass, oxide glass, or any combination thereof. Any desired mirror can be used as the insert 120, 420, and/or 620. In one example the insert 120, the insert 420, and/or the insert 620 can be a mirror. Illustrative mirrors can include, but are not limited to, aluminum glass mirrors, low aluminum glass mirrors, safety glass mirrors, silkscreen printed glass mirrors, silver glass mirrors, or any combination thereof. In another example, the insert 120, the insert 420, and/or 620 can be a combination of a paper having an advertisement or other information disposed thereon and acrylic glass. In another example, the insert 120, the insert 420, and/or the insert 620 can be or include a laminate, e.g., a resin coated paper laminate.

The first exterior layer 125, the intermediate layer 235, the second exterior layer 245, the first exterior layer 425, the second intermediate layer 450, the first intermediate layer 435, the third intermediate layer 455, the second exterior layer 445, the first exterior layer 625, the second intermediate layer 650, the first intermediate layer 635, the third intermediate layer 655, and the second exterior layer 645 can independently be or include, but are not limited to, a particleboard, an oriented strand board, a laminated strand lumber, waferboard, staved lumber, structural composite lumber, mineral door core, e.g., gypsum based door cores, an agrifiber door core, a fiberboards, e.g., medium density fiber boards and high density fiber boards, a plywood, solid wood, e.g., a board or veneer, a laminate, medium density overlay panels, or any combination thereof. In one example, referring to the door 400, the first exterior layer 425 and the second exterior layer 445 can be a laminate, the second intermediate layer 450 and the third intermediate layer 455 can be a fiberboard, e.g., a medium density fiberboard or a high density fiberboard, and the first intermediate layer 435 can be particle board or staved lumber. The laminate can include laminates commercially available from any number of suppliers. For example, the HD® HIGH DEFINITION® laminates, premium laminates, and standard laminates available from Wilsonart, LLC.

The first exterior layer 125, the intermediate layer 235, the second exterior layer 245, the first exterior layer 425, the second intermediate layer 450, the first intermediate layer 435, the third intermediate layer 455, the second exterior layer 445, the first exterior layer 625, the second intermediate layer 650, the first intermediate layer 635, the third intermediate layer 655, and the second exterior layer 645 can be secured to one another with one or more adhesives. Suitable adhesives for securing any two or more layers, e.g., the first exterior layer 125 and the intermediate layer 235, to one another can include, but are not limited to, polyvinyl acetates, urea-formaldehyde resins, phenol-formaldehyde resins, melamine-formaldehyde resins, resorcinol-formaldehyde resins, melamine-urea-formaldehyde resins, phenol-urea-formaldehyde resins, phenol-melamine-formaldehyde resins, phenol-resorcinol-formaldehyde resins, copolymers thereof, salts thereof, or derivatives thereof. In at least one example, any two or more layers, e.g., the first exterior layer 425 and the second intermediate layer 450 and/or the second intermediate layer 450 and the first intermediate layer 435 can be secured to one another with one or more polyvinyl acetates.

The recesses 240, 440, and/or 640 can be formed or otherwise made in the respective cores 245, 445, and 645 using any suitable method or process. For example, the a board, panel, or other body can be milled, cut, drilled, or otherwise mechanically acted on to remove material therefrom and form the recesses 240, 440, and/or 640. In another example, the cores 235, 435, and/or 635 can be composed of a plurality of particulates bonded to one another with a cured adhesive and the recesses 240, 440, and/or 640 can formed during manufacture via a mold or other forming device prior to curing the adhesive.

The doors 100, 400, and/or 600 can include, but are not limited to, one or more pieces of hardware. For example, the door 100, 400, and/or 600 can include one or more hinges, one or more door knobs, one or more locks, e.g., a deadbolt lock, one or more kick plates, address numbers, and other items generally secured to, within, and/or at least partially within doors.

Embodiments of the present disclosure further relate to any one or more of the following paragraphs:

1. A door, comprising: a plurality of layers secured to one another to form a body, wherein a recess is formed within the body and adapted to receive an insert; and an opening defined by at least a first exterior layer, wherein the opening is configured to expose a portion of the insert.

2. The door according to paragraph 1, wherein the body is particleboard, oriented strand board, laminated strand lumber, medium density fiberboard, high density fiberboard, plywood, solid wood, a laminate, or any combination thereof.

3. The door according to paragraph 1 or 2, further comprising the insert at least partially disposed within the recess.

4. The door according to paragraph 3, wherein the insert comprises a mirror, a chalk board, a dry erase board, wood, a laminate, glass, an electronic display, a light, or any combination thereof.

5. The door according to any one of paragraphs 1 to 4, wherein the body is configured to secure the insert within the recess.

6. The door according to any one of paragraphs 1 to 5, wherein the door is free of any molding.

7. A door, comprising: a body comprising a first exterior layer, a first intermediate layer, a middle layer, a second intermediate layer, and a second exterior layer, wherein: a recess defined by at least the middle layer, wherein the recess is configured to receive an insert, the first exterior layer and the first intermediate layer each define an opening therethrough, the openings defined by the first exterior layer and the first intermediate layer are configured to expose a portion of the insert, and the first exterior layer and the first intermediate layer are configured to at least partially secure the insert within the recess.

8. The door according to paragraph 7, wherein the first exterior layer, the first intermediate layer, the middle layer, the second intermediate layer, and the second exterior layer are independently particleboard, oriented strand board, laminated strand lumber, medium density fiberboard, high density fiberboard, plywood, solid wood, a laminate, or any combination thereof.

9. The door according to paragraph 7 or 8, further comprising the insert at least partially disposed within the recess.

10. The door according to paragraph 9, wherein the insert comprises a mirror, a chalk board, a dry erase board, wood, a laminate, glass, an electronic display, a light, or any combination thereof.

11. The door according to paragraph 9 or 10, wherein the insert contacts an inner surface of the first intermediate layer.

12. The door according to any one of paragraphs 7 to 11, wherein the first exterior layer is a laminate.

13. The door according to any one of paragraphs 7 to 12, wherein the second exterior layer is a laminate.

14. The door according to any one of paragraphs 7 to 13, wherein the first intermediate layer is a fiberboard.

15. The door according to any one of paragraphs 7 to 14, wherein the first intermediate layer is a high density fiberboard.

16. The door according to any one of paragraphs 7 to 15, wherein the second intermediate layer is a fiberboard.

17. The door according to any one of paragraphs 7 to 16, wherein the second intermediate layer is a high density fiberboard.

18. The door according to any one of paragraphs 7 to 17, wherein the middle layer is particleboard.

19. The door according to any one of paragraphs 7 to 18, wherein the middle layer is oriented strand board.

20. The door according to any one of paragraphs 9 to 19, wherein the insert is a mirror.

21. The door according to any one of paragraphs 9 to 19, wherein the insert is an electronic display.

22. The door according to any one of paragraphs 7 to 21, wherein the door is free of any molding.

23. A method for making a door, comprising: securing at least two layers to one another to produce a body, wherein: a recess is formed in a first layer, the recess is adapted to receive one or more inserts, a second layer defines one or more openings, and the one or more openings are configured to expose a portion of the one or more inserts.

24. The method according to paragraph 23, further comprising locating the insert at least partially within the recess.

25. The method according to paragraph 24, wherein the insert is located within the recess by passing the insert through a channel formed in the first layer.

26. The method according to paragraph 24, wherein the mirror is located within the recess after the at least two layers are secured to one another.

27. The method according to any one of paragraphs 23 to 26, wherein the second layer is adapted to secure the insert within the recess.

28. The method according to any one of paragraphs 23 to 27, wherein the door is free of any molding.

29. The method according to any one of paragraphs 23 to 28, wherein the first layer is particleboard, and wherein the second layer is a laminate.

30. The method according to any one of paragraphs 23 to 29, wherein the at least two layers are secured to one another with one or more adhesives.

31. The method according to any one of paragraphs 23 to 29, wherein the at least two layers are secured to one another with one or more thermosetting adhesives.

32. A door, comprising: a body comprising an intermediate layer disposed between a first exterior layer and a second exterior layer, wherein a recess is formed in the intermediate layer; and an insert at least partially disposed within the recess, wherein: an opening defined by a first end of the intermediate layer and the first exterior layer enables the insert to be removed from the recess to an exterior of the body, at least a portion of the insert is exposed to the exterior of the body through an opening defined by the first exterior layer, and the first exterior layer is in contact with the insert to retain the insert within the recess.

33. A door, comprising: a body comprising an intermediate layer disposed between a first exterior layer and a second exterior layer, wherein a recess is formed in the intermediate layer; and an insert at least partially disposed within the recess, wherein: the insert is at least partially disposed within the recess by passing the insert from an exterior of the body through an opening defined by a first end of the intermediate layer and the first exterior layer, and the insert is at least partially exposed to the exterior of the body through an opening defined by the first exterior layer.

34. A door, comprising: a body comprising an intermediate layer disposed between a first exterior layer and a second exterior layer, wherein a recess is formed in the intermediate layer; and an insert at least partially disposed within the recess, wherein: the insert is movable between the recess and an exterior of the body through an opening defined by a first end of the intermediate layer and the first exterior layer, and the insert is at least partially exposed to the exterior of the body through an opening defined by the first exterior layer.

35. The door according to any one of paragraphs 32 to 34, wherein: the first exterior layer comprises a laminate, a wood veneer, a medium density fiberboard, or a medium density overlay, the second exterior layer comprises a laminate, a wood veneer, a medium density fiberboard, or a medium density overlay, and the intermediate layer comprises a particleboard or a laminated strand lumber.

36. The door according to any one of paragraphs 32 to 35, wherein the door is free of any molding configured to retain the insert within the recess.

37. The door according to any one of paragraphs 32 to 36, wherein the insert is not secured within the recess with an adhesive or molding.

38. The door according to any one of paragraphs 32 to 37, wherein the insert comprises a silicate based glass, acrylic glass, a chalk board, a dry erase board, wood, a laminate, glass, paper, an electronic display, a light, or any combination thereof.

39. The door according to any one of paragraphs 32 to 38, wherein the insert comprises a mirror.

40. The door according to any one of paragraphs 32 to 39, wherein the first exterior layer prevents the insert from passing through the opening defined by first exterior layer.

41. The door according to any one of paragraphs 32 to 40, wherein at least a portion of the insert is disposed between the first exterior layer and the intermediate layer.

42. A door, comprising: a body comprising a first exterior layer, a first intermediate layer, a second intermediate layer, a third intermediate layer, and a second exterior layer, wherein: the second intermediate layer is disposed between the first exterior layer and the first intermediate layer, the third intermediate layer is disposed between the second exterior layer and the first intermediate layer, and a recess is formed in the first intermediate layer; and an insert at least partially disposed within the recess, wherein: an opening defined by a first end of the first intermediate layer and the second intermediate layer enables the insert to be removed from the recess to an exterior of the body, at least a portion of the insert is exposed to the exterior of the body through an opening defined by the first exterior layer and the second intermediate layer, and the second intermediate layer is in contact with the insert to retain the insert within the recess.

43. The door according to paragraph 42, wherein: the first exterior layer comprises a laminate, a wood veneer, a medium density fiberboard, or a medium density overlay, the first intermediate layer comprises a particleboard or a laminated strand lumber, the second intermediate layer comprises a medium density fiberboard or a high density fiberboard, the third intermediate layer comprises a medium density fiberboard or a high density fiberboard, and the second exterior layer comprises a laminate, a wood veneer, a medium density fiberboard, or a medium density overlay.

44. The door according to paragraph 42 or 43, wherein the door is free of any molding configured to retain the insert within the recess.

45. The door according to any one of paragraphs 42 to 44, wherein the insert is not secured within the recess with an adhesive or molding.

46. The door according to any one of paragraphs 42 to 45, wherein the insert comprises a silicate based glass, acrylic glass, a chalk board, a dry erase board, wood, a laminate, glass, paper, an electronic display, a light, or any combination thereof.

47. The door according to any one of paragraphs 42 to 46, wherein the insert comprises a mirror.

48. The door according to any one of paragraphs 42 to 47, wherein the second intermediate layer prevents the insert from passing through the opening defined by first exterior layer and the second intermediate layer.

49. The door according to any one of paragraphs 42 to 48, wherein at least a portion of the insert is disposed between the first exterior layer and the intermediate layer.

50. The door according to any one of paragraphs 42 to 49, wherein: the door is free of any molding configured to retain the insert within the recess, the insert is not secured within the recess with an adhesive, the insert comprises a mirror, the second intermediate layer prevents the insert from passing through the opening defined by first exterior layer and the second intermediate layer, and at least a portion of the insert is disposed between the first exterior layer and the intermediate layer.

51. A door, comprising: a body comprising a first exterior layer, a first intermediate layer, a second intermediate layer, a third intermediate layer, and a second exterior layer, wherein: the second intermediate layer is disposed between the first exterior layer and the first intermediate layer, the third intermediate layer is disposed between the second exterior layer and the first intermediate layer, a recess is formed in the first intermediate layer, the recess is configured to receive an insert through an opening defined by a first end of the intermediate layer and the second intermediate layer, the body is configured to expose only a portion of the insert to an exterior of the body through an opening defined by the first exterior layer and the second intermediate layer.

52. The door according to paragraph 51, wherein the insert is disposed within the recess.

53. The door according to paragraph 51 or 52, wherein: the door is free of any molding configured to retain the insert within the recess, the insert is not secured within the recess with an adhesive, and the insert comprises a mirror.

54. The door according to any one of paragraphs 32 to 41, wherein the insert is retained within the recess by only the first exterior layer and the intermediate layer.

55. The door according to any one of paragraphs 42 to 53, wherein the insert is retained within the recess by only the second intermediate layer and the first intermediate layer.

56. The door according to any one of paragraphs 32 to 54, wherein the insert is freely movable within the recess.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art. As used herein, the terms “top”, “bottom”, “upper”, “lower”, “side”, “left”, “right”, and other like terms refer to relative positions to one another and are not intended to denote a particular spatial orientation.

Various terms have been defined above. To the extent a term used in a claim is not defined above, it should be given the broadest definition persons in the pertinent art have given that term as reflected in at least one printed publication or issued patent. And if applicable, all patents, test procedures, and other documents cited in this application are fully incorporated by reference to the extent such disclosure is not inconsistent with this application and for all jurisdictions in which such incorporation is permitted.

While the foregoing is directed to certain illustrative embodiments, other and further embodiments of the invention can be devised without departing from the basic scope thereof, and the scope thereof is determined by the claims that follow.

What is claimed is:

1. A door, comprising:
a body comprising an intermediate layer disposed between a first exterior layer and a second exterior layer, wherein a recess is formed in the intermediate layer; and
an insert at least partially disposed within the recess, wherein:
an opening defined by a first end of the intermediate layer and the first exterior layer enables the insert to be removed from the recess to an exterior of the body,
at least a portion of the insert is exposed to the exterior of the body through an opening defined by the first exterior layer, and
the first exterior layer is in contact with the insert to retain the insert within the recess.

2. The door of claim 1, wherein:
the first exterior layer comprises a laminate, a wood veneer, a medium density fiberboard, a high density fiberboard, or a medium density overlay,
the second exterior layer comprises a laminate, a wood veneer, a medium density fiberboard, a high density fiberboard, or a medium density overlay, and
the intermediate layer comprises a particleboard or a laminated strand lumber.

3. The door of claim 1, wherein the door is free of any molding configured to retain the insert within the recess.

4. The door of claim 1, wherein the insert is not secured within the recess with an adhesive or molding.

5. The door of claim 1, wherein the insert comprises a silicate based glass, an acrylic glass, a chalk board, a dry erase board, wood, a laminate, a paper, an electronic display, a light, or any combination thereof.

6. The door of claim 1, wherein the insert comprises a mirror.

7. The door of claim 1, wherein the first exterior layer prevents the insert from passing through the opening defined by the first exterior layer.

8. The door of claim 1, wherein at least a portion of the insert is disposed between the first exterior layer and the intermediate layer.

9. A door, comprising:
a body comprising a first exterior layer, a first intermediate layer, a second intermediate layer, a third intermediate layer, and a second exterior layer, wherein:
the second intermediate layer is disposed between the first exterior layer and the first intermediate layer,
the third intermediate layer is disposed between the second exterior layer and the first intermediate layer, and
a recess is formed in the first intermediate layer; and
an insert at least partially disposed within the recess, wherein:
an opening defined by a first end of the first intermediate layer and the second intermediate layer enables the insert to be removed from the recess to an exterior of the body,
at least a portion of the insert is exposed to the exterior of the body through an opening defined by the first exterior layer and the second intermediate layer, and
the second intermediate layer is in contact with the insert to retain the insert within the recess.

10. The door of claim 9, wherein:
the first exterior layer comprises a laminate, a wood veneer, a medium density fiberboard, or a medium density overlay,
the first intermediate layer comprises a particleboard or a laminated strand lumber,
the second intermediate layer comprises a medium density fiberboard or a high density fiberboard,
the third intermediate layer comprises a medium density fiberboard or a high density fiberboard, and
the second exterior layer comprises a laminate, a wood veneer, a medium density fiberboard, or a medium density overlay.

11. The door of claim 9, wherein the door is free of any molding configured to retain the insert within the recess.

12. The door of claim 9, wherein the insert is not secured within the recess with an adhesive or molding.

13. The door of claim 9, wherein the insert comprises a silicate based glass, an acrylic glass, a chalk board, a dry erase board, wood, a laminate, paper, an electronic display, a light, or any combination thereof.

14. The door of claim 9, wherein the insert comprises a mirror.

15. The door of claim 9, wherein the second intermediate layer prevents the insert from passing through the opening defined by first exterior layer and the second intermediate layer.

16. The door of claim 9, wherein at least a portion of the insert is disposed between the first exterior layer and the intermediate layer.

17. The door of claim 9, wherein:
the door is free of any molding configured to retain the insert within the recess,
the insert is not secured within the recess with an adhesive,
the insert comprises a mirror,
the second intermediate layer prevents the insert from passing through the opening defined by first exterior layer and the second intermediate layer, and
at least a portion of the insert is disposed between the first exterior layer and the intermediate layer.

18. A door, comprising:
a body comprising a first exterior layer, a first intermediate layer, a second intermediate layer, a third intermediate layer, and a second exterior layer, wherein:
the second intermediate layer is disposed between the first exterior layer and the first intermediate layer,
the third intermediate layer is disposed between the second exterior layer and the first intermediate layer,
a recess is formed in the first intermediate layer,
the recess is configured to receive an insert through an opening defined by a first end of the intermediate layer and the second intermediate layer,
the body is configured to expose only a portion of the insert to an exterior of the body through an opening defined by the first exterior layer and the second intermediate layer.

19. The door of claim 18, wherein the insert is disposed within the recess.

20. The door of claim 19, wherein:
the door is free of any molding configured to retain the insert within the recess,
the insert is not secured within the recess with an adhesive, and
the insert comprises a mirror.
